(19) United States
(12) Patent Application Publication
(10) Pub. No.: US 2017/0237696 A1
(43) Pub. Date: Aug. 17, 2017

(54) Apparatus and Method for Mediating Uploadable Content

(71) Applicant: Shawn R. Spurr, Spring, TX (US)

(72) Inventor: Shawn R. Spurr, Spring, TX (US)

(21) Appl. No.: 15/041,199

(22) Filed: Feb. 11, 2016

(51) Int. Cl. H04L 12/58

(52) U.S. Cl. CPC H04L 51/12; H04L 51/32

(57) ABSTRACT

Embodiments provide an apparatus and method for mediating uploadable content.

### FIELD OF THE INVENTION

The present disclosure relates to a system and method for mediating uploadable content, more specifically a system and method for mediating content uploaded to a network.

### BACKGROUND OF THE INVENTION

Social media/texting is now a standard part of people's everyday lives. A large wing of social media is distributed over the Internet and cellular networks. This includes websites such as Facebook®, Twitter®, and LinkedIn® and may additionally include text messaging. Texting may additionally include sexting, which is commonly referencing the act of sending nude or explicit photos via text messaging.

Any information that the social media sites obtain can potentially be seen and heard by millions of people. Many users of social media, including teenagers, young children, normal people, and celebrities, have been scrutinized for what they post or text on certain social media sites. In addition, teenagers who send nude photos, and people that have a tendency to post controversial content, don't necessarily have any means of mediation to control what is posted.

### BRIEF SUMMARY OF THE INVENTION

The disclosure provides a plurality of methods and apparatuses for mediating uploadable content. In one embodiment, an apparatus including a content mediation application may send uploadable content to a content mediation application server for analysis and determination of whether the uploadable content comprises controversial content. If controversial content is found, the uploadable content may be deleted or otherwise prevented from distribution. If controversial content is not found, the uploadable content may be saved and sent to a final destination, such as, but not limited to a social media server and a text application server. Alternatively, the uploadable content may be sent to a social media network or text application network, where the content may be viewed within a social media application or a text application. In embodiments, the uploadable content may comprise at least one of an image file (such as, for example, a JPG or PNG file), a text message, a sound file, and a video file.

It is noted that the content mediation application may act as a “masking application”, which, in terms of this application, may refer to a first application that may run content from one or more second applications within the first application. Instead of being able to upload information input into the first application to a server of the second applications (such as a social media server), the first application may only upload the uploadable content to a first application server (in embodiments, a content mediation application server).

Alternatively, the uploadable content may be sent from a first electronic device to a second electronic device. Embodiments may require that both electronic devices include a content mediation application. An analysis/determination in the form of user input may be input into the content mediation application of the second electronic device. Based on the determination, the second electronic device may perform at least one of a number of functions, such as those previously mentioned.

In embodiments, apparatuses utilized for the aforementioned methods may comprise a plurality of elements. An apparatus may comprise: a processor, a memory containing an operating system, and a display for displaying information on the apparatus. The apparatus may further include a graphical user interface in communication with the display. The graphical user interface may be adapted to receive user input via touch and typing, for example.

The apparatus may further include at least one application associated with a social media platform. In embodiments, the at least one application may be associated with a social media platform that may be configured to receive uploadable content in the form of user input. It is noted that, in embodiments, user input may be text typed into the screen of an apparatus by an individual or a gesture performed on a graphical user interface by an individual that allows an apparatus to carry out a function. The apparatus may further include a content mediation application in communication with a content mediation server. The content mediation application may be, at least, in communication with the at least one application and the operating system.

The content mediation application may be configured to perform a number of tasks. The content mediation application may monitor at least one application associated with social media, which may also be referred to as “active monitoring.” To perform the “active monitoring”, the content mediation application may provide, to the individual, an access portal to applications associated with a social media platform. This means that an account associated with an application associated with a social media platform may be accessed, logged into, and controlled through the content mediation application. Any information concerning what an individual performs while logged in may be stored in a memory associated with the content mediation application. In embodiments, this may include the uploadable content. The content mediation application may further be configured to upload the uploadable content to a server connected to the content mediation application. The functions performed may change based on how many electronic devices utilize the content mediation application.

In embodiments, systems utilized for the aforementioned methods may comprise a plurality of elements. The apparatus may be used in conjunction with the server in communication with the apparatus via a network. The server may be configured to receive uploadable content in the form of user input over the network. A second memory may be linked to the server and the processor that may be capable of storing at least one of the uploadable content and at least one destination address. A controversial content identifiers database may be linked to the server. In embodiments, the database may be provided an index of controversial content identifiers each comprising at least one depiction deemed to be inappropriate.

A second processor may be linked to the server and the second memory. The second processor may be configured to filter the uploadable content to determine if the uploadable content comprises at least one controversial content identifier. The “filtering” may further include parsing the uploadable content and the at least one depictions in order to correlate like elements. For example, if a text is being analyzed, words in the text may be separately analyzed and matched against what is located in the index of controversial content identifiers. As a second example, specific portions of an image file may be separately analyzed (such as separate groups of pixels) and matched against what is located in the index of controversial content identifiers. The second processor may further provide a determination to the apparatus over the network. To show an indication of status, the uploadable content may be “marked” or denoted with a variable that may indicate whether the uploadable content does or does not include at least one controversial content identifier.

Based on the determination, the system may perform at least one of a number of functions. If the uploadable content has been marked as not having controversial content, the processor may perform at least one of: finishing the uploading of the uploadable content to the server in connection with the content mediation application and sending the uploadable content to at least one social media platform for transmission thereto. If the uploadable content has not been marked as having controversial content, the processor may delete the uploadable content. In either instance of the uploadable content having or not having controversial content, the uploadable content may be stored in the memory connected to the processor.

The aforementioned methods and systems may prevent an individual from posting in appropriate content on a public website that may harm their, or another's, reputation. Without this technology an individual, such as a sports star, may accidentally post content on a public website that may get them into trouble. If the sports star utilizes the above system, the sports star may be provided a personal content analyzer that may verify that information being posted is appropriate or not. Individuals who may follow this sports star (such as children/their parents) may have peace of mind knowing that they will not see controversial content when viewing content relative to the sports star. The system may provide benefits to multiple individuals, whether they are directly and/or indirectly associated with the system.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with skill in the art upon examination of the accompanying FIGURES and detailed description. It is intended that all such additional systems, methods, features and advantages that are included within this description, be within the scope of any claims filed now or later.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays a computing system and related peripherals that may operate with the method and apparatus for mediating uploadable content in accordance with embodiments.

FIG. 2 depicts a computer-implemented method for mediating uploadable content in accordance with embodiments.

FIG. 3 displays an apparatus used in mediating uploadable content performed on a phone in accordance with embodiments.

FIG. 4 displays a system for mediating uploadable content in accordance with embodiments.

FIG. 5 displays an alternative computer-implemented method for mediating uploadable content in accordance with embodiments.

FIG. 6 displays a first apparatus used in mediating uploadable content in accordance with embodiments.

FIG. 7 displays a system for mediating uploadable content in accordance with embodiments.

FIG. 8 displays an information flow diagram embodying a method for mediating uploadable content in accordance with embodiments.

FIG. 9 displays an information flow diagram embodying a method for mediating uploadable content in accordance with embodiments.

FIG. 10 displays an information flow diagram embodying a method for mediating uploadable content in accordance with embodiments.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

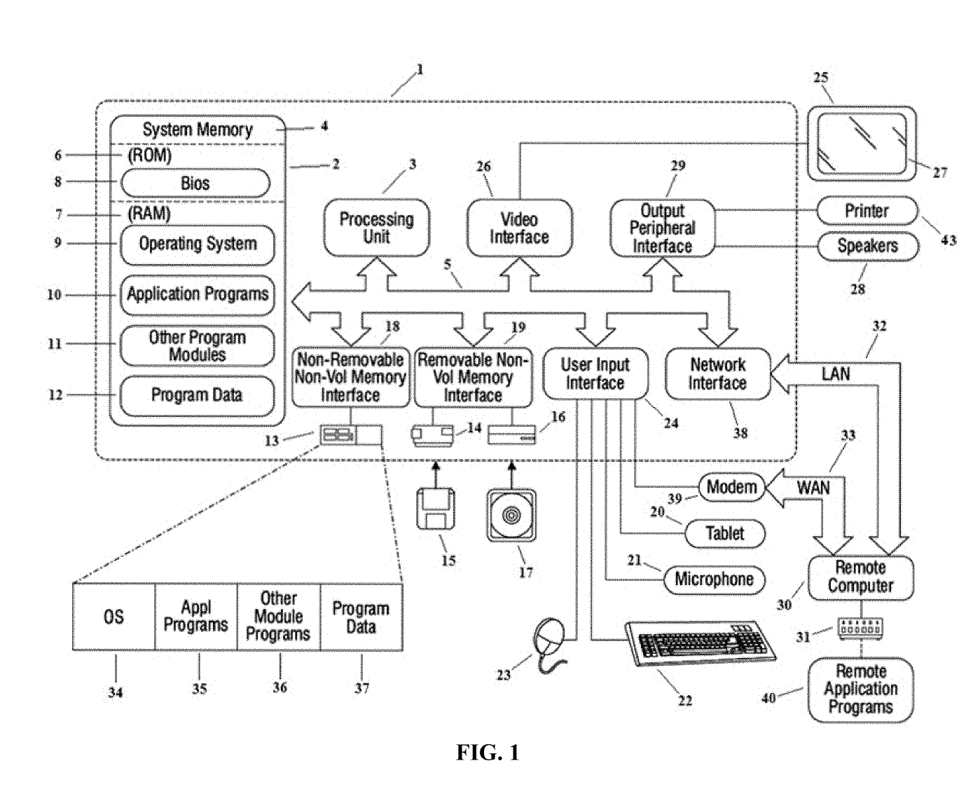

With reference to FIG. 1, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system (BIOS) 8, containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11, and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36, and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

Referring to FIG. 1, for the purposes of this disclosure, it will be appreciated that remote computer 30 may include any suitable terms such as, but not limited to “device”, “processor based mobile device”, “mobile device”, “electronic device”, “processor based mobile electronic device”, “mobile electronic device”, “wireless electronic device”, “location-capable wireless device,” and “remote device” including a smart phone or tablet computer.

The central processor operating pursuant to operating system software such as, but not limited to Apple IOS®, Google Android®, IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module, or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

It is noted that computing system 1 may be synonymous with at least one of first electronic device and second electronic device. In embodiments, at least one of the first electronic device and the second electronic device may comprise one or more elements found within computing system 1.

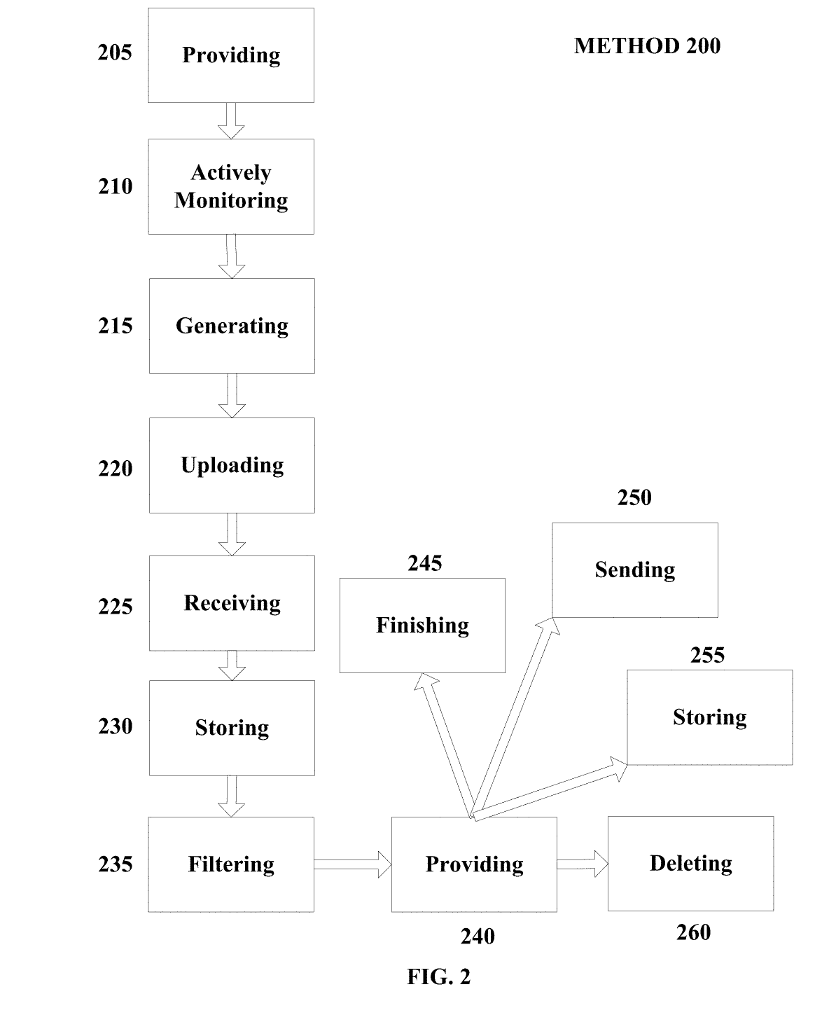

FIG. 2 depicts a computer-implemented method 200 for mediating uploadable content in accordance with embodiments. Method 200 may depict one scenario in which uploadable content 410 may be mediated. Elements utilized may include an electronic device 300, a content mediation application 335, and a content mediation application server 340. Method 200 may comprise providing 205 a content mediation application for installation on at least a first electronic device 300. The first electronic device 300 may be in the possession of an individual that may be susceptible to posting and/or sending controversial content on social media platforms and in text messages.

The first electronic device 300 may include at least one application associated with a social media platform 345 which may be actively monitored 210 via embodiments of the content mediation application 335. To perform the “active monitoring” 210, the content mediation application 335 may provide, to the individual, an access portal to applications associated with a social media platform 345. This means that an account associated with an application 330 associated with a social media platform 345 may be accessed, logged into, and controlled through the content mediation application 335. Any information concerning what an individual performs while logged in may be stored in a memory (such as 310) associated with the content mediation application 335. In embodiments, this may include the uploadable content 410. It is noted that the content mediation application 335 may be thought of as a “masking application”, which may be an application that may perform functions of a social media application 330 that may affect the content within the social media application 330 as well as what is saved on the platform 345 associated with that social media application 330.

Once the individual is logged in, the individual may generate 215 uploadable content 410 via user input put into the graphical user interface 325 of the first electronic device 300. Other information, such as information contained in user input, may also affect the content within a social media application 335 as well as the platform associated with the social media application 335. Once displayed on the display 315 of first electronic device 300, an uploading 220 to a content mediation application server 340 may be carried out via additional user input (such as the individual actuating an “enter” icon on the display 315). Normally, an uploading 220 of a user input may send the user input to a social media platform 345 to be posted. Alternatively, in this scenario, the uploadable content 410 may be sent to the content mediation application server 340 in order to be analyzed. At this point, the uploadable content 410 may not be sent to the social media platform 345 and network. In embodiments, the uploadable content 410 may include at least one of an image file, a text message, a video file, and a sound file. It is noted that the content mediation application server 340 may be different than that of the social media platform 345.

The content mediation application server 340 may then receive 225 the uploadable content 410 from the first electronic device 300 over a network 405. It is at this point that the uploadable content 410 may be analyzed to see if there is any controversial content within the uploadable content 410. This may be carried out with the utilization of a controversial content identifiers database 430 linked to the content mediation application server 420. The database 430 may store an index of controversial content identifiers that may each comprise at least one element deemed to be inappropriate. In embodiments, the controversial content identifiers may be words or portions of words. In embodiments, the controversial content identifiers may be patterns and/or agglomerations of specifically colored pixels that may be used to match against what is found in the uploadable content 410. Before the analysis of the uploadable content 410, the uploadable content 410 and at least one destination address associated with the uploadable content 410 may be stored 230 on a memory 415 of the server 420. In embodiments, the at least one destination address may be associated with at least one social media server 345.

The processor 425 associated with the content mediation application server 420 may then perform one or more steps to carry out the analysis of the uploadable content 410. The processor 425 may filter 235 the uploadable content to determine if the uploadable content 410 comprises at least one controversial content identifier. This may be carried out by comparing aspects of the uploadable content 410 to the controversial content identifiers in order to find like elements between the uploadable content 410 and the controversial content identifiers. The “filtering” may further include parsing the uploadable content 410 and the at least one depictions in order to correlate like elements. For example, if a text is being analyzed, words in the text may be separately analyzed and matched against what is located in the index of controversial content identifiers. As a second example, specific portions of an image file may be separately analyzed (such as separate groups of pixels) and matched against what is located in the index of controversial content identifiers. If the uploadable content 410 does comprise a controversial content identifier, the uploadable content 410 may be assigned a variable denoting the uploadable content 410 as having at least one controversial content identifier. If the uploadable content 410 does not comprise a controversial content identifier, the uploadable content 410 may be denoted as not having any controversial content identifiers.

A determination based on the variable assigned to the uploadable content may be provided 240 to the first electronic device 300 over the network 405. In embodiments, the determination may be viewable within the application 335 on the display 315 of the first electronic device 300. The determination may be stored on at least one of the memory 310 of the first electronic device 300 and the memory 310 in communication with the processor 305,425 providing the determination.

Based on the determination, the processor 305,425 may perform at least one of a number of functions. If the uploadable content has been marked as not having controversial content, the processor 305,425 may perform at least one of: uploading 245 the uploadable content 410 to the server 420 in connection with the content mediation application 335 and sending 250 the uploadable content 410 to a social media platform 345 for transmission to a social media application 330. If the uploadable content 410 has not been marked as having controversial content, the processor 305,425 may delete the uploadable content 410. In either instance of the uploadable content 410 having or not having controversial content, the uploadable content 410 may be stored in the memory 415 connected to the processor 305,425.

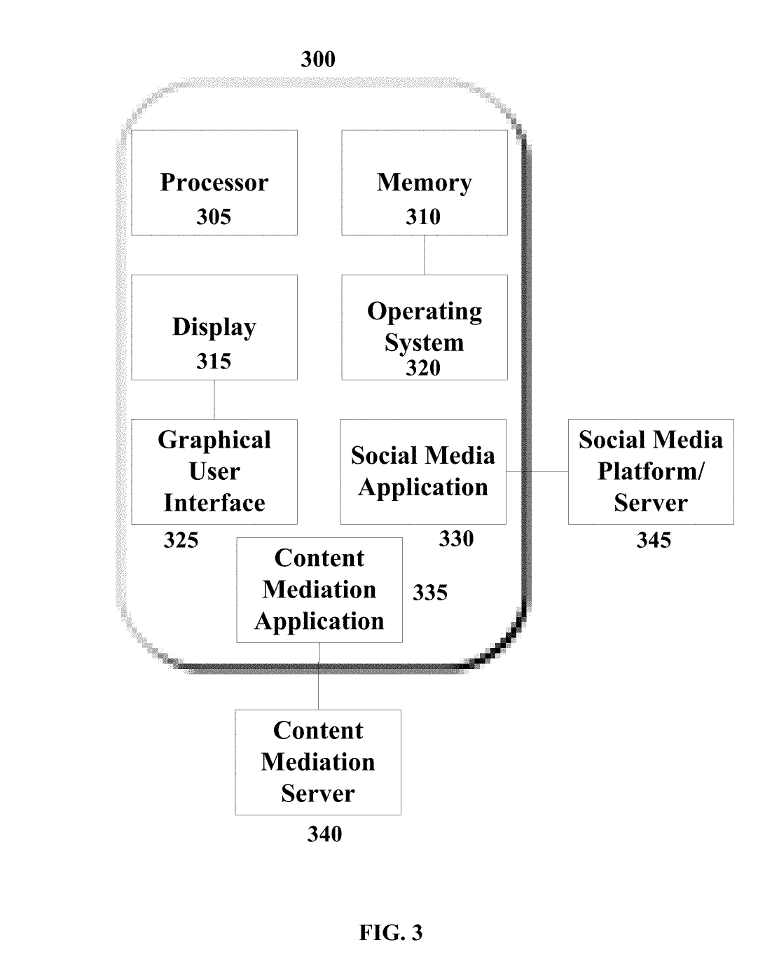

FIG. 3 displays an apparatus 300 for mediating uploadable content 410 in accordance with embodiments. The apparatus 300 may comprise a processor 305, a memory 310 including an operating system 320, and a display 315 for displaying information on the apparatus 300. The apparatus 300 may further include a graphical user interface 325 in communication with the display 315. The graphical user interface 325 may be adapted to receive user input via touch and typing, for example. In embodiments, the operating system 320 may be similar to the operating system 34 found in system 1 of FIG. 1.

Apparatus 300 may further include at least one application 330 associated with a social media platform 345. In embodiments, the at least one application 330 may be associated with a social media platform 345 that may be configured to receive uploadable content 410 in the form of user input. It is noted that “user input” may be, in embodiments, text input into the graphical user interface 325 and/or a gesture of an individual that triggers the apparatus 300 to perform a function.

Apparatus 300 may further include a content mediation application 335 operated by a content mediation server 340. The content mediation application 335 may be, at least, in communication with the at least one application 330 and the operating system 320 (memory 310). It is noted that the at least one social media application 330 and the content mediation application 335 may be stored on the memory 310 of apparatus 300. The content mediation application 335 may be configured to perform a number of tasks. The content mediation application 335 may monitor at least one application 330 associated with social media, which may also be referred to as “active monitoring.” To perform the “active monitoring”, the content mediation application 335 may provide, to the individual, an access portal to applications 330 associated with a social media platform 345. This means that an account associated with an application 330 associated with a social media platform 345 may be accessed, logged into, and controlled through the content mediation application 335. Any information concerning what an individual performs while logged in may be stored in a memory 310 associated with the content mediation application 335. In embodiments, this may include the uploadable content 410. It is noted that the content mediation application 335 may be thought of as a “masking application”, which may be an application that may perform functions of a social media application 330 that may affect the content within the social media application 330 as well as what is saved on the platform 345 associated with that social media application 330. The content mediation application 335 may further be configured to upload the uploadable content 410 to a server 340 in connection with the content mediation application 335. In embodiments, the server 340 may be different than the social media platform 345.

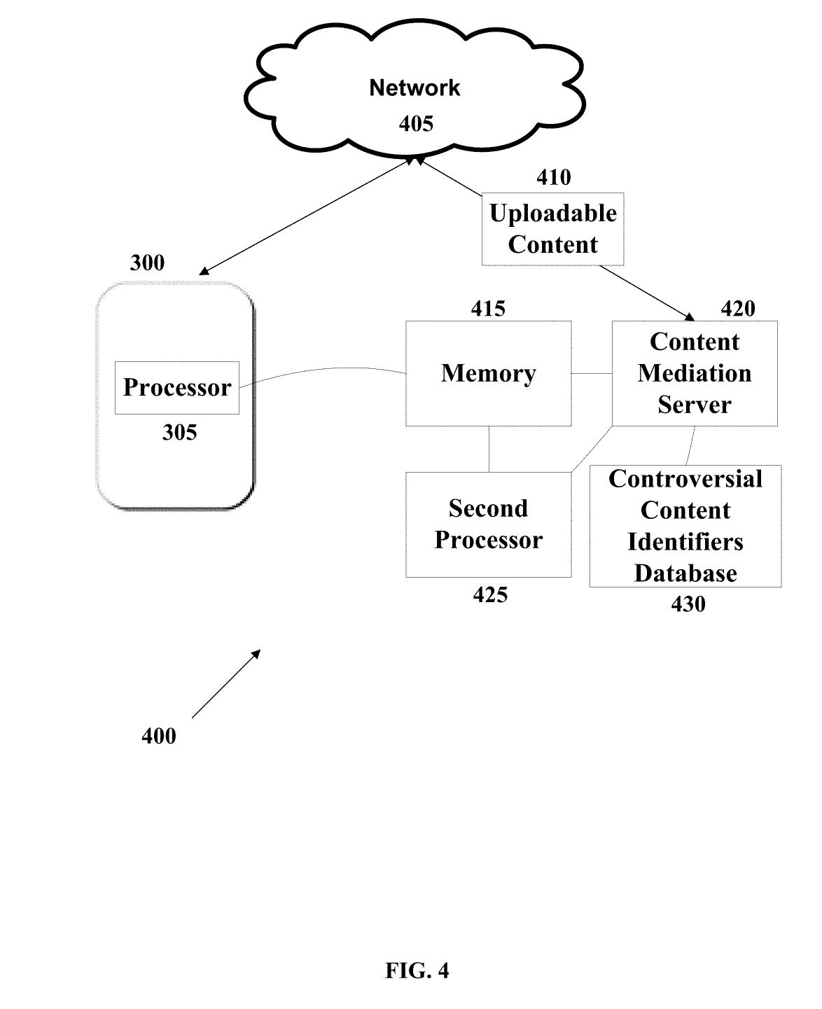

FIG. 4 displays a system 400 for mediating uploadable content 410 in accordance with embodiments. In embodiments, the apparatus 300 may be used in conjunction with the server 420 in communication with the apparatus 300 via a network 405. The server 420 may be configured to receive uploadable content 410 in the form of user input over the network 405. A second memory 415 may be linked to the server 420 and the processor 305,425 that may be capable of storing at least one of the uploadable content 410 and at least one destination address. In embodiments, at least one destination address may be a social media server 345 or social media site. A controversial content identifiers database 430 may be linked to the server 420. In embodiments, the database 430 may store an index of controversial content identifiers each comprising at least one depiction deemed to be inappropriate. The content mediation application 335 found on the apparatus 300 may be installable on at least the apparatus 300. In embodiments, the content mediation application 335 may be capable of displaying information related to the uploadable content 410.

A second processor 425 may be linked to the server 420 and the second memory 415. The second processor 425 may be capable of filtering (as previously described) the uploadable content 410 to determine if the uploadable content 410 comprises at least one controversial content identifier. The second processor 425 may further provide a determination to the apparatus 300 over the network of whether the uploadable content 410 comprises controversial content. To show an indication of status, the uploadable content 410 may be “marked” or denoted that may indicate whether the uploadable content 410 does or does not include at least one controversial content identifier.

Based on the determination, the processor 305,425 may perform at least one of a number of functions. If the uploadable content 410 has been marked denoting that the uploadable content 410 does not have controversial content, the processor 305,425 may perform at least one of: uploading of the uploadable content 410 to the server 420 in connection with the content mediation application 335 and sending the uploadable content 410 to the at least one application 330 associated with a social media platform 345 for transmission to a social media site. If the uploadable content 410 has been marked denoting that the uploadable content 410 has controversial content, the processor 305,425 may delete the uploadable content 410. In either instance of the uploadable content 410 having or not having controversial content, the uploadable content 410 may be stored in the memory 310,415 connected to the processor 305,425.

In embodiments, the apparatus 300 may be a mobile electronic device.

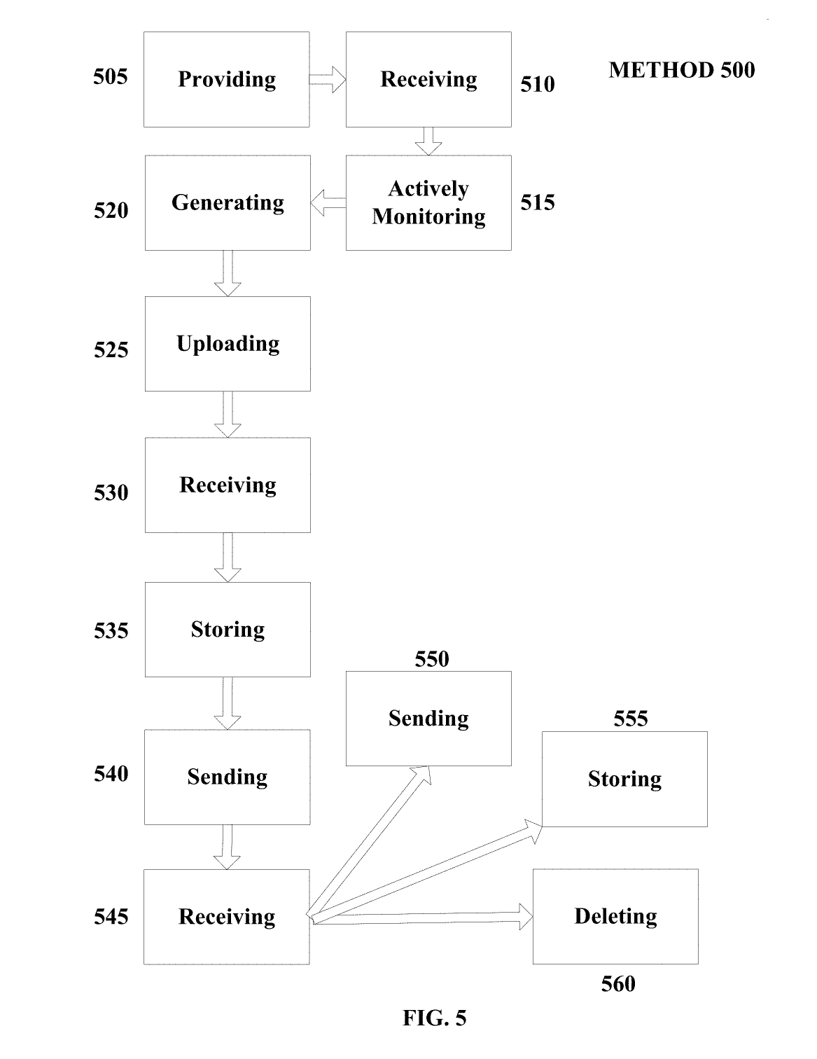

FIG. 5 displays an alternative computer-implemented method 500 for mediating uploadable content 410 in accordance with embodiments. Method 500 may depict one scenario in which uploadable content 410 may be mediated. Elements utilized may include a first electronic device 600, a second electronic device 650, at least two content mediation applications 735, and a content mediation application server 720. Method 500 may comprise providing 505 a content mediation application 635 for installation on at least a first electronic device 600 and a second electronic device 650. In embodiments, the content mediation application 635 may perform different functions based on what electronic device the content media application 635 is installed.

The first electronic device 600 may then receive 510, via the content media application 635, sending protocol. The sending protocol may be executable by an electronic device to send, from the first electronic device 600 to the second electronic device 650, uploadable content 410 by way of a server 640 in connection with the content mediation application 635. At least one application 630 associated with a social media platform 645 may then be actively monitored 515 on the first electronic device 600 via the content mediation application 635. The “active monitoring” may be similar to the “active monitoring” of method 200.

Uploadable content 410 may then be generated 520 on the first electronic device 600 via user input. In embodiments, the uploadable content 410 may be generated within the at least one application 630 associated with a social media platform 645 on the first electronic device 600. The content mediation application 635 may further be configured to upload 525 the uploadable content 410 to a server 640 in connection with the content mediation application 635. In embodiments, the server 640 may be different than the social media platform 645.

The uploadable content 410 may then be received 530 and stored 535 by the server 640 from the first electronic device 600 over a network 705. At least one destination address may be stored 535 as well as the uploadable content 410 on a memory 715 connected to the server 640. The server 640 may then send 540 the uploadable content 410 and the at least one destination address to the second electronic device 650 and may be accessible via the content mediation application 635 of the second electronic device 650. It is noted that, in embodiments, the uploadable content 410 may further comprise information including aspects of the second electronic device 650 such as, but not limited to, an IP address. This may allow the server 640 to send the uploadable content 410 to the correct “mediating” electronic device.

Once the uploadable content 410 is received 530 by the second electronic device, the uploadable content 410 may be viewable to an individual in possession of the second electronic device 650. The second electronic device 650 may receive 545, via a graphical user interface (not shown, similar to 625) of the second electronic device 650, user input. The user input may comprise determination information correlating with the uploadable content 410. For example, the user input may correlate with an allowance of the uploadable content 410 to be sent and uploaded to a social media platform 645.

Based on the determination, the processor/second processor 605,725 may perform at least one function. If it is determined that the uploadable content 410 does not contain controversial content, the processor 605,725 may perform at least one of sending 550 the uploadable content 410 to the at least one application 630 associated with a social media platform 645 for transmission thereto and storing 555 the uploadable content 410 in the memory 610,715 linked to the processor 605,725. If it is determined that the uploadable content 410 contains controversial content, the processor 605,725 may delete 560 the uploadable content 410, keeping the controversial content from being posted within a social media network. In embodiments, the uploadable content 410 may comprise at least one of an image file, a text message, a sound file, and a video file. In embodiments, the at least one destination address may be associated with the at least one social media platform 645.

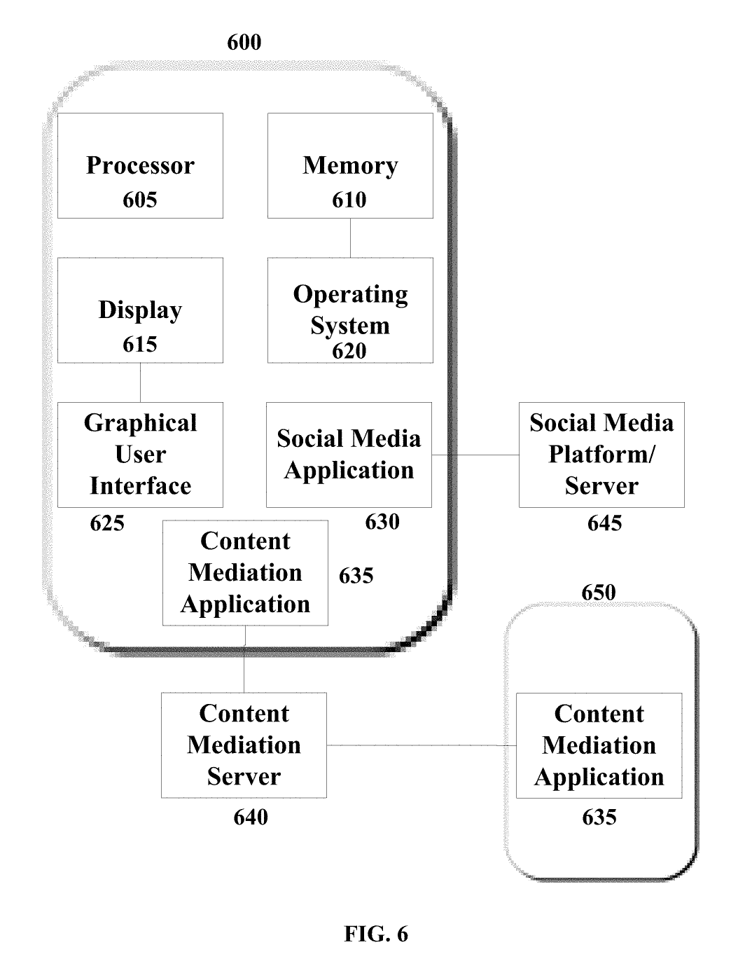

FIG. 6 displays a first apparatus 600 for mediating uploadable content 410 in accordance with embodiments. The first apparatus 600 may comprise elements and a setup similar to that of apparatus 300. The content mediation application 635 of the first apparatus 600 may be configured to perform one or more functions. The content mediation application 635 may be capable of monitoring at least one application 630 associated with social media. This “monitoring” may be similar to the “active monitoring” as previously mentioned.

The content mediation application may further be capable of uploading the uploadable content 410 to a server 640 (different than the social media platform 645) in connection with the content mediation application 635. The uploadable content 410 may be sent from the server 640 to a second apparatus 650 comprising the content mediation application 635. This may allow an individual in possession of the second apparatus 650 to view and analyze the uploadable content 410.

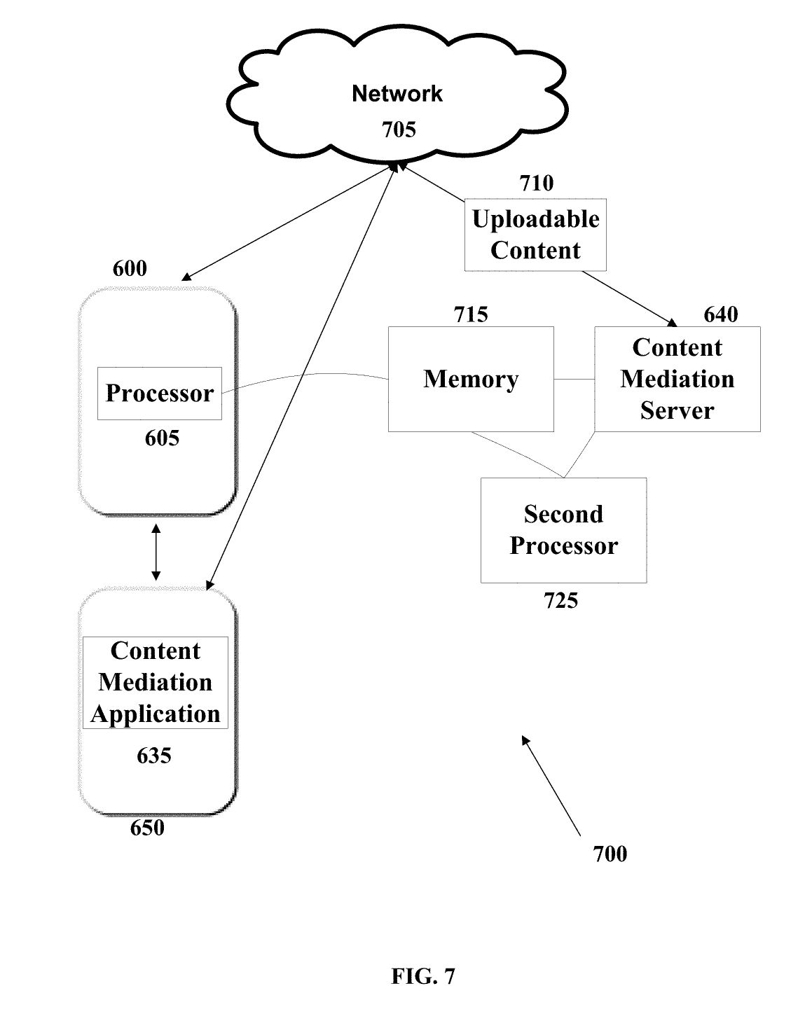

FIG. 7 displays a system 700 for mediating uploadable content 410 in accordance with embodiments. In embodiments, the first apparatus 600 may be used in conjunction with the server 640 in communication with the first apparatus 600 and the second apparatus 650 via a network 705. The server 640 may be configured to receive uploadable content 410 in the form of user input over the network 705. A second memory 715 linked to the server 640 may be capable of storing at least one of the uploadable content 410 and at least one destination address of the uploadable content 410. A content mediation application 635 installable on at least the first apparatus 600 and the second apparatus 650 may be capable of displaying information related to the uploadable content 410. In embodiments, the at least one destination address may be associated with the at least one social media platform 645.

A second processor 725 may be linked to the server 640 and the second memory 715 and may be capable of performing a number of tasks. The second processor 725 may send the controversial content to the controversial content application 635 on the second apparatus 650. Once analyzed by the second apparatus 650 (which may include receiving user input in the form of a determination by the second apparatus 650), the second processor 725 may receive a determination from the second apparatus 650 over the network. In embodiments, the determination may be a determination of whether the uploadable content 410 comprises controversial content in the form of user input.

Based on the determination, the second processor 725 may further perform at least one of a number of functions. The second processor 725 may send the uploadable content 410 to at least one social media platform 645 associated with the at least one application 630. Once the uploadable content 410 is sent to a social media server 645, the uploadable content 410 may then be uploaded to a social media network, where it may be viewable via a social media application 630. The second processor 725 may additionally store the uploadable content 410 in the second memory 715 in addition to sending the uploadable content 410. The uploadable content 410 may alternatively be deleted by the second processor 725. The uploadable content 410 may be deleted in response to the uploadable content 410 being determined that the uploadable content 410 contains controversial content. In embodiments, the uploadable content 410 may comprise at least one of an image file, a text message, a sound file, and a video file. In embodiments, at least one of the first apparatus 600 and the second apparatus 650 may be a mobile electronic device.

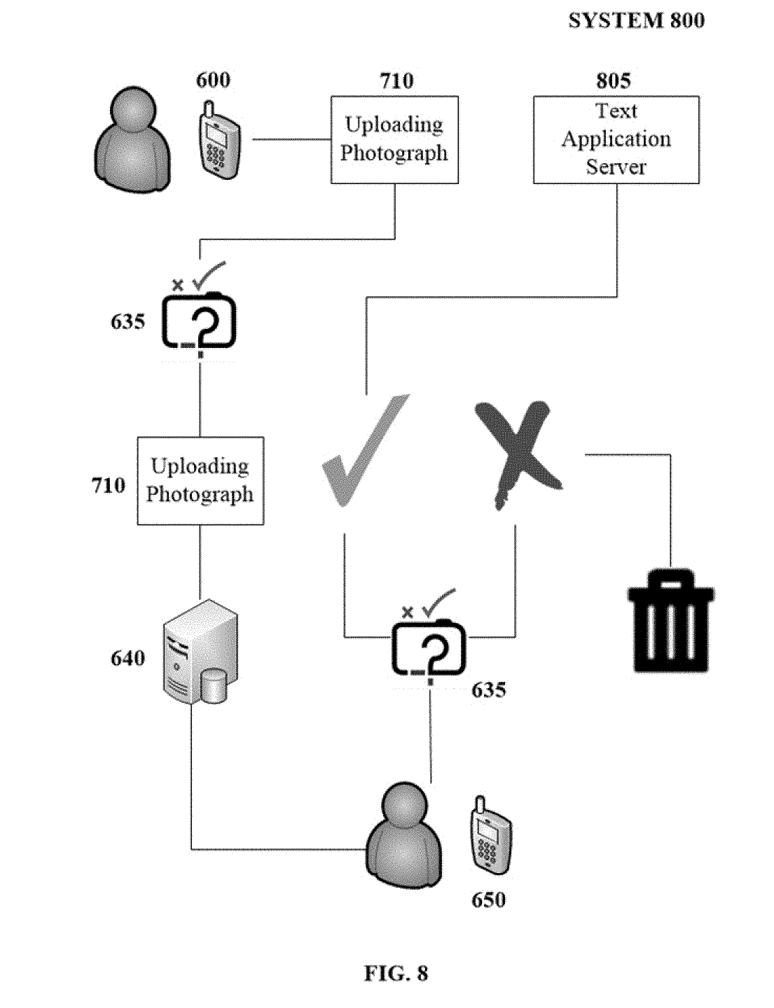

FIG. 8 displays an information flow diagram 800 embodying a method for mediating uploadable content 410 in accordance with embodiments. For the purposes of this disclosure, the steps and elements displayed may be similar to those found in FIG. 7 except as disclosed below. The controversial content application 635 found on the second electronic device 650 may be capable of carrying out a function different than that of the controversial content application 635 found in FIG. 7. When an individual with a first electronic device 600 attempts to send an uploading photograph 710 using the controversial content application 635, the uploading photograph 710 may be sent to a server 640 associated with the controversial content application 635. The uploading photograph 710 may then be sent to a second electronic device 650 of a second individual where the photograph 710 may be received within a controversial content application 635 on the second electronic device 650. The controversial content application 635 may allow an individual to provide user input to the electronic device 650 in the form of two options: an acceptance of the uploading photograph 710 in the form of an engageable acceptance icon and a rejection of the uploading photograph 710 in the form of an engageable rejection icon. If the engageable acceptance icon is engaged, the uploading photograph 710 may be sent to a text application server 805 from the second electronic device 650, which, from the server 640, may subsequently upload the uploadable content 410 to a text application network. The uploadable content 410 may then be viewable on a text application found on an electronic device, such as a third electronic device (not shown) that is not the first electronic device 600 or the second electronic device 650. If the engageable rejection icon is engaged, the uploading photograph 710 may be deleted.

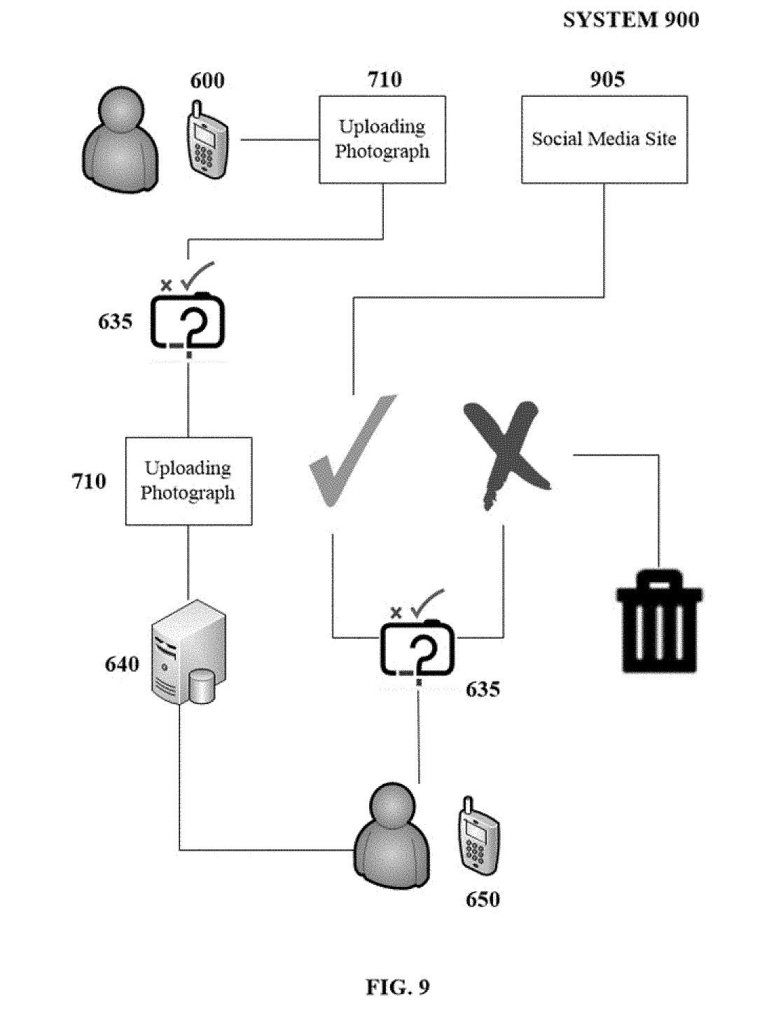

FIG. 9 displays an information flow diagram 900 embodying a method for mediating uploadable content 410 in accordance with embodiments. As an example, an uploading photograph 710 may be utilized as “uploadable content.” When an individual with a first electronic device 600 attempts to send an uploading photograph 710 using the controversial content application 635, the uploading photograph 710 may be sent to a server 640 associated with the controversial content application 635. The uploading photograph 710 may then be sent to a second electronic device 650 of a second individual where the photograph 710 may be received within a controversial content application 635 on the second electronic device 650. The controversial content application 635 may allow an individual to provide user input to the electronic device 650 in the form of two options: an acceptance of the uploading photograph 710 in the form of an engageable acceptance icon and a rejection of the uploading photograph 710 in the form of an engageable rejection icon. If the engageable acceptance icon is engaged, the uploading photograph 710 may be sent to a social media site from the second electronic device 650, which, from the server 640, can be forwarded to a social media network and posted to a social media site 905. If the engageable rejection icon is engaged, the uploading photograph 710 may be deleted.

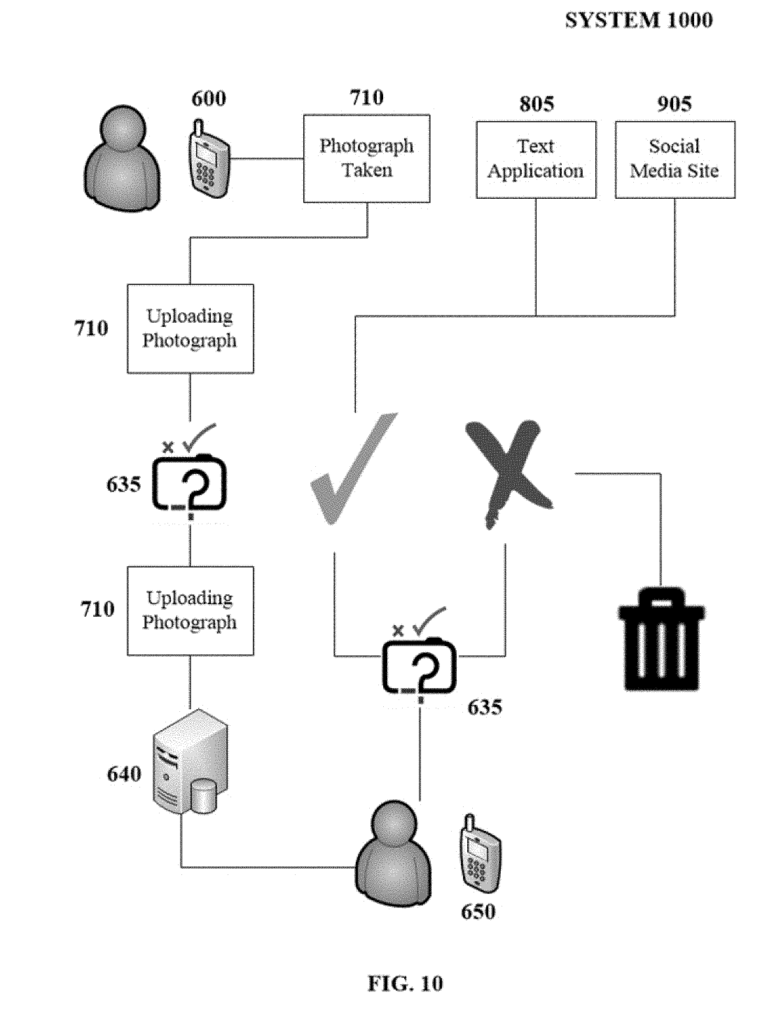

FIG. 10 displays an information flow diagram 1000 embodying a method for mediating uploadable content 410 in accordance with embodiments. For the purposes of this disclosure, the steps and elements displayed may be similar to those found in FIGS. 7, 8, and 9 except as disclosed below. The controversial content application 635 found on the second electronic device 650 may be capable of carrying out a plurality of functions that may be similar to the functions disclosed for FIGS. 7, 8, and 9. The controversial content application 635 may upload the uploadable content 410 to a social media platform 905 as well as upload the uploadable content 410 to text application server 805.

In embodiments, the uploading photograph 710 may be sent to a text application server 805 from the second electronic device 650, which, from the server 805, can be forwarded to a text application on a third electronic device (not shown). In embodiments, the uploading photograph 710 may be sent to a text application server 805 and a social media server 905 from the second electronic device 650, which, from the servers 805,905, can be forwarded to a social media network and a text application on a third electronic device (not shown). From the social media network, the uploading photograph 710 may be posted to a social media site 905. In embodiments, the uploading photograph 710 may be uploading text.

It is noted that the content mediation application 335,635 may act as a “masking application”, which, in terms of this application 335,635, may refer to a first application that may run content from one or more second applications within the first application. But instead of being able to upload information input into the first application to a sever of the second applications (such as a social media server), the first application may only upload the uploadable content 410 to a first application server (in embodiments, a content mediation application server 340,640).

For the purposes of this disclosure, the terms, “social media server” and social media platform” may be synonymous.

What is claimed is:

1. A computer-implemented method for mediating uploadable content, the method comprising:
providing a content mediation application for installation on at least a first electronic device;
actively monitoring, via the content mediation application, at least one application associated with a social media platform;
generating, via user input, the uploadable content on the first electronic device, the uploadable content generated within the content mediation application on the first electronic device;
uploading the uploadable content to a server in connection with the content mediation application, the server different than the social media platform;
receiving, at the server, uploadable content from the first electronic device over a network, the server linked to a controversial content identifiers database, the database storing an index of controversial content identifiers, the controversial content identifiers each comprising at least one element deemed to be inappropriate;
storing the uploadable content and at least one destination address associated with the uploadable content on a memory of the server, wherein the processor
parses the uploadable content to determine if the uploadable content comprises at least one controversial content identifier;
provides a determination to the first electronic device over the network;
and
based on the determination, performs at least one of:
sending the uploadable content from the server to the content mediation application server;
sending the uploadable content to the at least one social media platform for transmission to at least one application associated with a social media platform;
storing the uploadable content in the memory; and
deleting the uploadable content;
wherein the parsing of uploadable content with controversial content protects an individual from scrutiny from the general public by preventing the uploadable content from posting on a social media site.

2. The method of claim 1, the uploadable content comprising at least one of an image file, a text message, a sound file, and a video file.

3. The method of claim 1, the at least one destination address associated with at least one social media server.

4. An apparatus for mediating uploadable content, the apparatus comprising:
a processor;
a display;
a graphical user interface, the graphical user interface in communication with the display, the graphical user interface for receiving user input;
a memory, the memory having stored thereon an operating system, at least one application associated with a social media platform, the at least one application associated with a social media platform configured to receive uploadable content in the form of user input, and a content mediation application operated by a content mediation server, the content mediation application at least in communication with the at least one application and the operating system, the content mediation application configured to:
monitor at least one application associated with social media; and
upload the uploadable content to a server in connection with the content mediation application, the server different than the social media platform.

5. The apparatus of claim 4, further comprising:
the server in communication with the apparatus via a network, the server configured to receive uploadable content in the form of user input over the network;
a second memory linked to the server and the processor, the memory capable of storing at least one of the uploadable content and at least one destination address;
a controversial content identifiers database linked to the server, the database storing an index of controversial content identifiers, the controversial content identifiers each comprising at least one depiction deemed to be inappropriate;
the content mediation application installable on at least the apparatus, the content mediation application capable of displaying information related to the uploadable content;
a second processor linked to the server and the second memory, the second processor configured to:
filter the uploadable content to determine if the uploadable content comprises at least one controversial content identifier;
provide a determination to the apparatus over the network;
and
based on the determination, perform at least one of:
sending the uploadable content to the at least one social media platform for transmission to at least one application associated with a social media platform;
storing the uploadable content in the second memory; and
deleting the uploadable content;
wherein the parsing of uploadable content with controversial content protects an individual from scrutiny from the general public by preventing the uploadable content from posting on a social media site.

6. The apparatus of claim 4, the uploadable content comprising at least one of an image file, a text message, a sound file, and a video file.

7. The apparatus of claim 4, the at least one destination address associated with at least one social media server.

8. The apparatus of claim 4, the apparatus being a mobile electronic device.

9. A computer-implemented method for mediating uploadable content, the method comprising:
providing a content mediation application for installation on at least a first electronic device and a second electronic device;
receiving, via the content media application, sending protocol, the sending protocol executable to send, from the first electronic device to the second electronic device, uploadable content by way of a server in connection with the content mediation application;
actively monitoring on the first electronic device, via the content mediation application, at least one application associated with a social media platform;
generating, via user input, the uploadable content on the first electronic device, the uploadable content generated within the at least one application associated with a social media platform on the first electronic device;
uploading the uploadable content to the server in connection with the content mediation application, the server different than the social media platform;
receiving, via the server, uploadable content from the first electronic device over a network;
storing the uploadable content and at least one destination address associated with the uploadable content on a memory of the server;
sending, via the server, the uploadable content and the at least one destination address associated with the uploadable content to the second electronic device, the uploadable content accessible via the content mediation application of the second electronic device;
receiving, via a graphical user interface of the second electronic device, user input, the user input comprising determination information correlating with the uploadable content;
and
based on the determination, performing one of the following:
sending the uploadable content to the at least one application associated with a social media platform for transmission thereto;
storing the uploadable content in the memory; and
deleting the uploadable content.

10. The method of claim 8, the uploadable content comprising at least one of an image file and a text message.

11. The method of claim 8 the at least one destination address associated with the at least one social media platform.

12. A first apparatus for mediating uploadable content, the apparatus comprising:
a processor;
a memory;
a display;
a graphical user interface, the graphical user interface in communication with the display, the graphical user interface for receiving user input;
at least one application associated with a social media platform, the at least one application associated with a social media platform configured to receive uploadable content in the form of user input;
an operating system;
a content mediation application operated by a content mediation server, the content mediation application at least in communication with the at least one application and the operating system, the content mediation application configured to:
monitor at least one application associated with social media; and
upload the uploadable content to a server in connection with the content mediation application, the server different than the social media platform, the uploadable content sent from the server to a second apparatus comprising the content mediation application.

13. The apparatus of claim 11, further comprising:
the server in communication with the first apparatus and the second apparatus via a network, the server configured to receive uploadable content in the form of user input over the network;
a second memory linked to the server, the memory capable of storing at least one of the uploadable content and at least one destination address;
the content mediation application installable on at least the first apparatus and the second apparatus, the content mediation application capable of displaying information related to the uploadable content;
a second processor linked to the server and the second memory, the processor capable of:
sending the controversial content to the controversial content application on the second apparatus;
receiving a determination from the second apparatus over the network;
and
based on the determination, performing at least one of:
sending the uploadable content to at least one social media platform associated with the at least one application;
storing the uploadable content in the second memory; and
deleting the uploadable content.

14. The apparatus of claim 11, the uploadable content comprising at least one of an image file and a text message.

15. The apparatus of claim 11, the at least one destination address associated with the at least one social media platform.

16. The apparatus of claim 11, at least one of the first apparatus and the second apparatus being a mobile electronic device.
